(19) United States
(12) Patent Application Publication
(10) Pub. No.: US 2018/0336580 A1
(43) Pub. Date: Nov. 22, 2018

(54) EVALUATION DEVICE, EVALUATION METHOD, AND STORAGE MEDIUM

(71) Applicant: HONDA MOTOR CO., LTD., Tokyo (JP)

(72) Inventor: Takumi KATO, Tokyo (JP)

(21) Appl. No.: 15/960,778

(22) Filed: Apr. 24, 2018

(30) Foreign Application Priority Data
May 17, 2017 (JP) 2017-098349

(51) Int. Cl. G06Q 30/02; G06N 3/08; G06N 3/04; G06K 9/66; G06K 9/62

(52) U.S. Cl. CPC G06Q 30/0202; G06N 3/08; G06K 9/6215; G06K 9/66; G06N 3/0436

(57) ABSTRACT

An evaluation device according to one aspect of the present invention includes a feature extractor configured to extract a first feature value of a first design which is an evaluation target, a similarity calculator configured to calculate similarity between the first design and each of a plurality of existing second designs on the basis of the first feature value extracted by the feature extractor, and a predictor configured to predict a customer's impression of the first design on the basis of similarity calculated by the similarity calculator and information indicating a customer's impression of each of the second designs previously acquired.

### CROSS-REFERENCE TO RELATED APPLICATIONS

This application is based upon and claims the benefit of priority from Japanese Patent Application No. 2017-098349, filed on May 17, 2017; the entire contents of which are incorporated herein by reference.

### BACKGROUND OF THE INVENTION

### Field of the Invention

The present invention relates to an evaluation device, an evaluation method, and a storage medium.

### Description of Related Art

A sensitivity evaluation method using various indicators has been proposed in the field of sensitivity engineering in which human sensitivity to a design and the like is evaluated. For example, a method of performing evaluation in which evaluation methods used by humans are simulated and evaluating a texture of the surface of a target has been proposed in Japanese Unexamined Patent Application, First Publication No. 2015-184184. In addition, a method of evaluating an image by expressing the image of a target as a one-dimensional quantity that can be evaluated by human sensitivity has been proposed in Japanese Unexamined Patent Application, First Publication No. 2016-143355. In addition, various sensitivity evaluation methods have been proposed (refer to PCT International Publication No. WO2014/080509, PCT International Publication No. WO2011/158965, Japanese Unexamined Patent Application, First Publication No. 2008-225582, Japanese Unexamined Patent Application, First Publication No. 2006-205783, and Japanese Unexamined Patent Application, First Publication No. 2006-209244).

### SUMMARY OF THE INVENTION

However, it is not easy to quantitatively evaluate human sensitivity to targets, and a unified evaluation indicator has not been defined yet. In addition, it is a general approach to actually present a product to a customer, to allow the customer to see and touch it, and to ask the customer to evaluate it with scores for various items in a sensitivity evaluation method in the related art. Since design is highly confidential information in the field of manufacturing, it is not easy to collect customer's comments. In addition, the use of neuroscience has become active in quantitatively evaluating human sensitivity with small numbers of samples, but heavy equipment such as a magnetic resonance image device (MRI) capable of examining the blood flow and the like in the brain becomes necessary, and expenses required for evaluation increase. For this reason, a method capable of securing confidentiality and quantitatively evaluating the sensitivity of customers in a simple manner is required.

The present invention provides an evaluation device, an evaluation method, and a storage medium which are capable of securing confidentiality and quantitatively evaluating the sensitivity of customers in a simple manner.

(1) An evaluation device according to a first aspect of the present invention includes a feature extractor (for example, a feature extractor 12 in an embodiment) configured to extract a first feature value of a first design which is an evaluation target, a similarity calculator (for example, a similarity calculator 32 in the embodiment) configured to calculate similarity between the first design and each of a plurality of existing second designs on the basis of the first feature value extracted by the feature extractor, and a predictor (for example, an evaluator 18 or a design score calculator 34 in the embodiment) configured to predict a customer's impression of the first design on the basis of similarity calculated by the similarity calculator and information indicating a customer's impression of each of the second designs previously acquired.

(2) In the above-described (1), the evaluation device further includes a model generator (for example, a model generator 30 in the embodiment) configured to generate, by learning a pair of a second feature value extracted from each of the plurality of second designs by the feature extractor and information indicating the customer's impression of each of the second designs obtained from an information medium, an evaluation model indicating a relationship between the second feature value and the information indicating the customer's impression.

(3) In the above-described (1) or (2), the predictor is configured to calculate a design score obtained by converting the customer's impression of the first design into a numerical value.

(4) In the above-described any one of (1) to (3), the evaluation device further includes an analyzer (for example, an analyzer 16 in the embodiment) configured to calculate scores obtained by applying tags indicating predetermined types of information indicating a customer's impression to data obtained from an information medium and converting information indicating the customer's impression into a numerical value for each of the applied tags.

(5) In the above-described any one of (1) to (4), the first design is a design of an unreleased vehicle and each of the second designs is a design of a released vehicle.

(6) In the above-described (1), the predictor is configured to predict a customer's impression of a new design image by performing machine learning of appearance images of existing vehicles and information indicating customer's impressions of the appearance images of existing vehicles.

(7) An evaluation method according to a second aspect of the present invention includes extracting a first feature value of a first design which is an evaluation target, calculating similarity between the first design and each of a plurality of existing second designs on the basis of the extracted first feature value, and predicting a customer's impression of the first design on the basis of the calculated similarity and information indicating a customer's impression of each of the second designs previously acquired.

(8) A non-transitory computer-readable storage medium according to a third aspect of the present invention storing an evaluation program, which when executed by a computer, causes the computer to extract a first feature value of a first design which is an evaluation target, calculate similarity between the first design and each of a plurality of existing second designs on the basis of the extracted first feature value, and predict a customer's impression of the first design on the basis of the calculated similarity and information indicating a customer's impression of each of the second designs previously acquired.

According to the above-described (1), (2), (3), (4), (6), (7), and (8), the confidentiality of a design which is an evaluation target can be secured, and the sensitivity of customers can be quantitatively evaluated in a simple manner.

According to the above-described (5), for example, it is possible to secure the confidentiality of an unreleased design which is newly developed in a process of developing a new car and to quantitatively evaluate the sensitivity of customers to the design.

### BRIEF DESCRIPTION OF THE DRAWINGS

FIG. 1 is a functional block diagram which shows an example of an evaluation device (learning stage) according to an embodiment.

FIG. 2 is a functional block diagram which shows an example of the evaluation device (evaluation stage) according to the embodiment.

FIG. 3 is a flowchart which shows an example of the flow of processing in the learning stage of the evaluation device according to the embodiment.

FIG. 4 is a diagram which shows an example of the structure of a convolution neural network used in the embodiment.

FIG. 5 is a diagram which shows an example of a sensitivity tag set to each of sensitivity categories and sensitivity words belonging to each of the sensitivity categories in the embodiment.

FIG. 6 is a diagram which shows an example of results of scoring according to the embodiment.

FIG. 7 is a flowchart which shows an example of the flow of processing in an evaluation stage of the evaluation device according to the embodiment.

FIG. 8 is a diagram which shows calculation processing of similarity and a design score according to the embodiment.

### DETAILED DESCRIPTION OF THE INVENTION

Hereinafter, an evaluation device, an evaluation method, and a storage medium according to an embodiment of the present invention will be described with reference to the drawings.

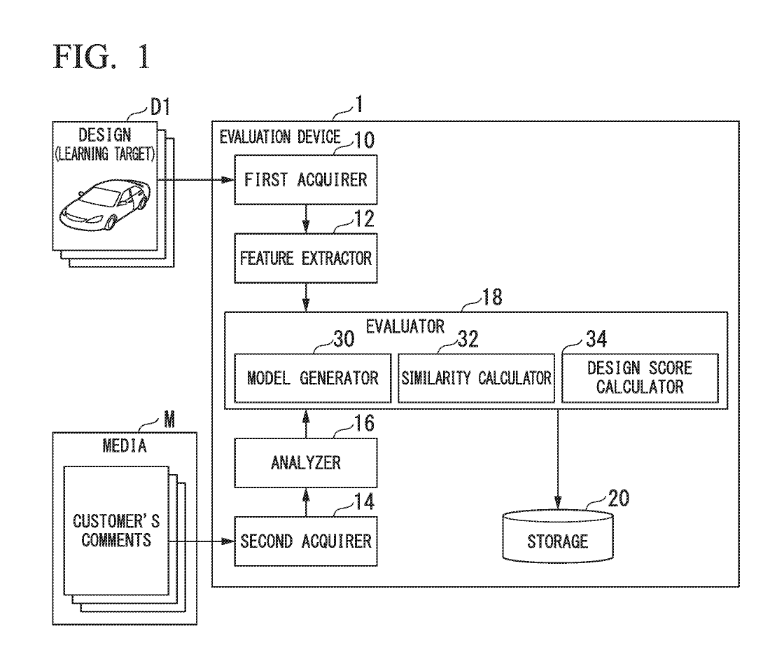

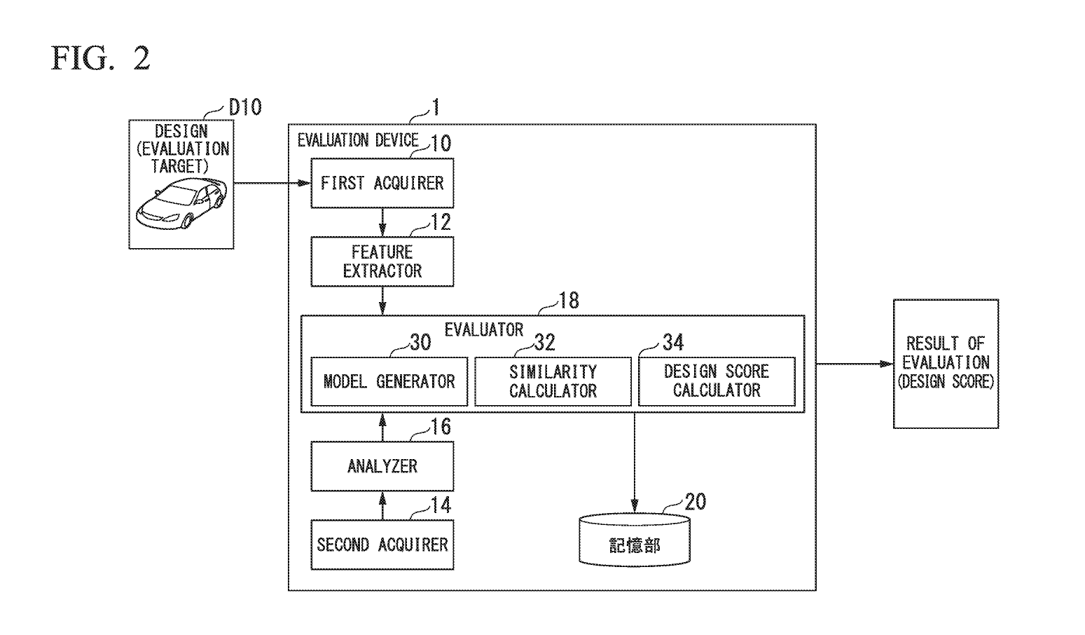

FIGS. 1 and 2 are functional block diagrams which show examples of an evaluation device 1 according to the present embodiment. FIG. 1 shows input and output states in a learning stage of the evaluation device 1, and FIG. 2 shows input and output states in an evaluation stage of the evaluation device 1. The evaluation device 1 associates the image of a design (second design) which is a learning target with sensitivity (information indicating the impression of customers) extracted from the customer's comments (the evaluation of customers) with respect to the learning target to generate an evaluation model. In addition, the evaluation device 1 predicts the sensitivity to a design (first design) which is an evaluation target and quantifies it using the evaluation model in the evaluation stage. Hereinafter, an example in which the evaluation target is a “vehicle” will be described.

The evaluation device 1 includes, for example, a first acquirer 10, a feature extractor 12, a second acquirer 14, an analyzer 16, an evaluator 18 (predictor), and a storage 20. The evaluator 18 includes, for example, a model generator 30, a similarity calculator 32, and a design score calculator 34 (predictor).

The first acquirer 10 acquires an image D1 of the design of a vehicle which is a learning target in a learning stage. For example, the evaluation device 1 includes a receiver (not shown) which receives an input from an operator, and the first acquirer 10 acquires the image D1 received by this receiver. The image D1 is, for example, an image of the appearance (exterior design) of an existing (previously released) vehicle. The exterior design covers, for example, the side from the front of the vehicle. The image D1 includes images of n vehicle types (n is an integer of one or more). In addition, the image D1 of the design of a vehicle includes a plurality of images for each of these n vehicle types.

The image D1 may be collected by crawling processing in which images and the like on the Internet associated with predefined character strings (for example, predefined vehicle names) are periodically collected.

The image D1 may include an image in which the background of a vehicle is white or an image in which the background has no features. The image D1 may include an image having a predetermined size (for example, 256×256 pixels). The image D1 may include images generated by performing rotation processing or light and shade change processing on a certain image.

The first acquirer 10 acquires an image D10 of the design of a vehicle which is an evaluation target in the evaluation stage. The first acquirer 10 acquires, for example, the image D10 input by an operator via a receiver (not shown). The image D10 is, for example, an image of the exterior design of an unreleased vehicle which is newly developed in a process of developing a new vehicle. The image D10 of the design of a vehicle may include a sketch image or the like.

The feature extractor 12 extracts a feature value (second feature value) of a design from the image D1 acquired by the first acquirer 10 in the learning stage. The feature extractor 12 uses, for example, a convolution neural network (CNN) which is a type of deep learning. The feature extractor 12, for example, converts the image D1 into a vector and turns it into a numerical value. This vector is given a vehicle name label. The vehicle name may be distinguished by a grade. Moreover, the feature extractor 12 extracts a feature value of the design of each vehicle by performing deep learning on this vector and the vehicle name label. In addition, the feature extractor 12 extracts a feature value of a design (first feature value) from the image D10 acquired by the first acquirer 10 in the evaluation stage.

The second acquirer 14 acquires processing target data S including the customer's comments on each vehicle which is a learning target in the learning stage. For example, the evaluation device 1 may include a receiver (not shown) for receiving an input from an operator, and the second acquirer 14 may acquire the processing target data S received by this receiver. The processing target data S includes, for example, data acquired from media M (information media). The media M include, for example, websites (question and answer sites), weblogs, SNSs such as short message services, television, newspapers, magazines, web articles, and shareholder reports. The second acquirer 14 may also acquire results of various questionnaires answered by the purchaser of a vehicle as the processing target data S.

The second acquirer 14 may also acquire the processing target data S including the customer's comments on each vehicle via, for example, the Internet. In this case, the second acquirer 14 may perform crawling processing to periodically acquire documents on the Internet including predefined character strings (for example, a predefined vehicle name) and the like. The second acquirer 14 may collect processing target data at a predetermined timing such as daily or weekly.

The analyzer 16 performs morphological analysis processing of dividing text contained in the processing target data S acquired by the second acquirer 14 into words in the learning stage. The analyzer 16 applies a tag identifying a type of sensitivity (hereinafter referred to as a “sensitivity tag”) to an expression including words (hereinafter referred to as “sensitivity words”) belonging to a predefined category of sensitivity (hereinafter referred to as a “sensitivity category”).

In addition, the analyzer 16 performs syntax analysis processing to interpret strength and weakness, multiple negation, positive question, dependency, and comparison of word expressions included in the text of the processing target data S. The details of the syntax analysis processing will be described below.

The evaluator 18 sets a pair of the feature value of a design extracted by the feature extractor 12 and a sensitivity tag applied by the analyzer 16 as teacher data, performs machine learning thereon for each vehicle in the learning stage, and generates an evaluation model M. The evaluator 18 uses, for example, a support vector machine. The model generator 30 included in the evaluator 18 generates the evaluation model M described above.

In addition, the evaluator 18 predicts and evaluates the sensitivity of customers to the image D10 of a design which is an evaluation target in the evaluation stage, and outputs a score (hereinafter referred to as a “design score”) which is obtained by converting the sensitivity of customers to the design of the image D10 into a numerical value as a result of the evaluation. That is, the evaluator 18 predicts a customer's impression of a new design image by performing machine learning of appearance images of existing vehicles and information indicating customer's impressions of the appearance images of existing vehicles. The similarity calculator 32 included in the evaluator 18 calculates similarity indicating how similar the image D10 is to each of n vehicle types learned in the learning stage using the feature value extracted from the image D10 and the evaluation model M. Then, the design score calculator 34 included in the evaluator 18 calculates a design score on the basis of similarity calculated by the similarity calculator 32 and a sensitivity tag associated with each of n vehicle types defined in the evaluation model M.

Some or all of the first acquirer 10, the feature extractor 12, the second acquirer 14, the analyzer 16, and the evaluator 18 are realized by a processor (computer) executing a program (software). In addition, some or all of these may be realized by hardware such as a large scale integration (LSI) or an application specific integrated circuit (ASIC), and may also be realized by a combination of software and hardware. Each functional unit included in the evaluation device 1 may be distributed to a plurality of devices.

The storage 20 stores the evaluation model M generated by the evaluator 18. The storage 20 may be realized by, for example, a random access memory (RAM), a read only memory (ROM), a hard disk drive (HDD), a flash memory, or a hybrid type storage device in which two or more of these are combined.

### (Learning Stage)

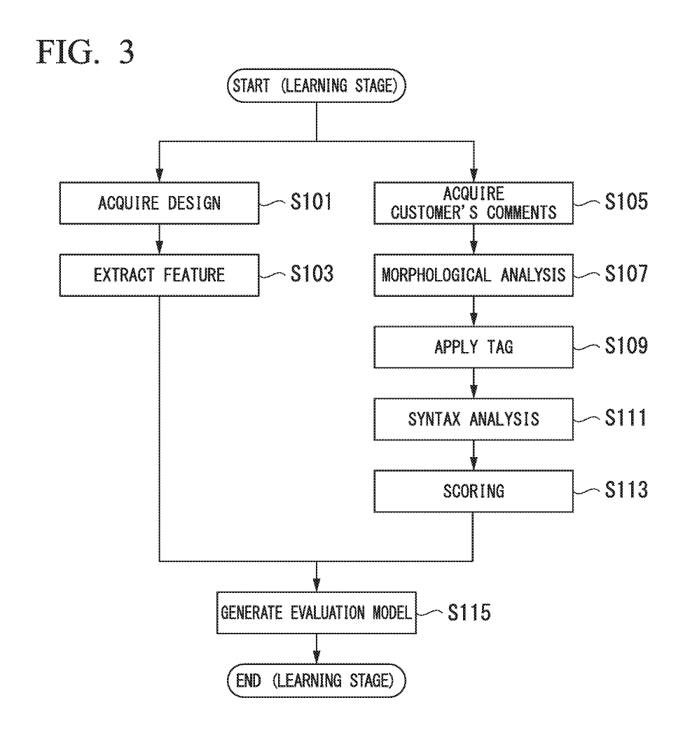

Hereinafter, a leaning stage operation of the evaluation device 1 according to the present embodiment will be described. FIG. 3 is a flowchart which shows an example of the flow of processing in the learning stage of the evaluation device 1 according to the present embodiment.

First, the first acquirer 10 acquires the image D1 of the design of a vehicle which is a learning target (step S101). The first acquirer 10 acquires, for example, the image D1 input by an operator via a receiver (not shown).

Next, the feature extractor 12 extracts the feature value of a design from the image D1 acquired by the first acquirer 10 (step S103). The feature extractor 12 uses, for example, a convolution neural network which is a type of deep learning.

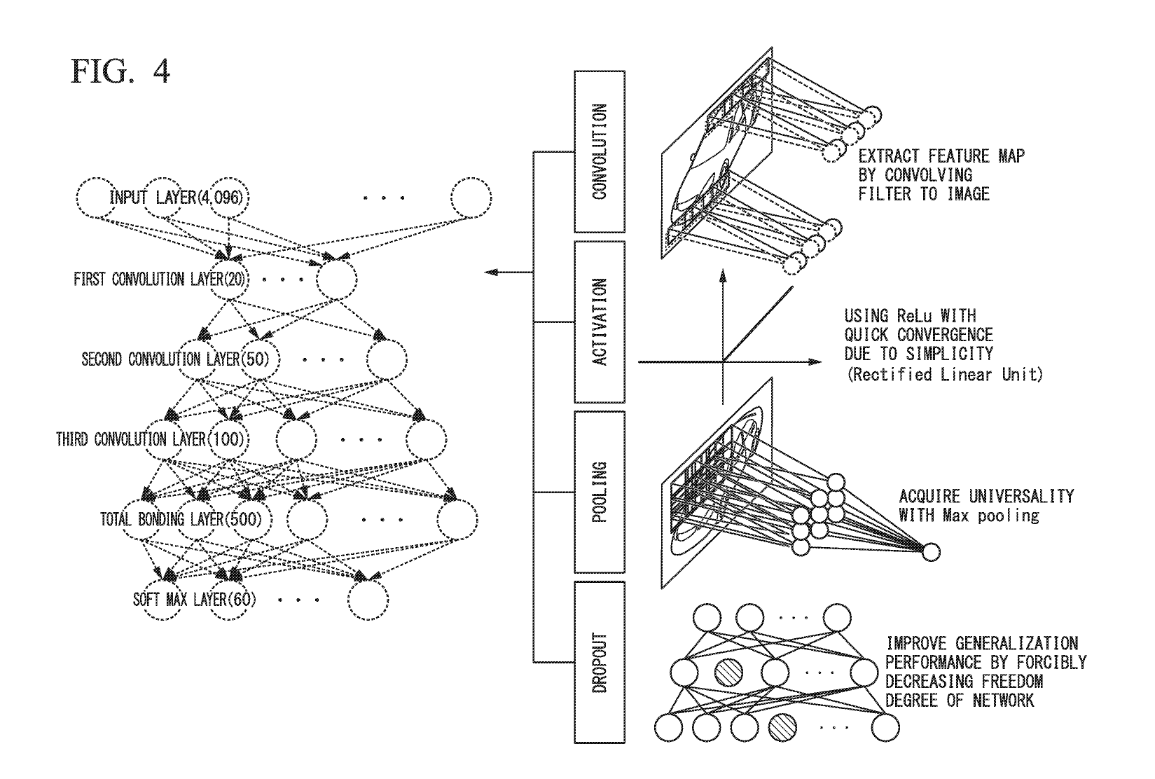

FIG. 4 is a diagram which shows an example of the structure of a convolution neural network used in the present embodiment. As shown in FIG. 4, the convolution neural network includes, for example, an input layer, convolution layers including three layers (first to third convolution layers), a total bonding layer, and a soft max layer. The input layer is compressed to 4096 dimensions. In a convolution layer, in addition to convolution processing in which a feature map is extracted by convolving filter to an image and activation processing using a normalized linear function (Rectified Linear Unit (ReLU)) as an intermediate layer activation function, dropout processing is introduced and generalization performance is enhanced so that there is no overfitting. The unit selection probability p of dropout is set to p=0.5 at which a regularization effect is maximized. Although there is a disadvantage that the range is not bounded, ReLU has merits such as not only propagation without attenuation of the gradient for a unit that takes a positive value but also quick convergence due to simplicity.

Before, after, or in parallel with the processing (step S101 and step S103) with respect to the image D1 described above, the following processing of the processing target data S including the customer's comments on each vehicle is performed.

First, the second acquirer 14 acquires the processing target data S including the customer's comments on each vehicle which is a learning target (step S105). The second acquirer 14 acquires the processing target data S input by an operator via, for example, a receiver (not shown).

Next, the analyzer 16 performs morphological analysis processing to divide text included in the processing target data S acquired by the second acquirer 14 into words (step S107). Then, the analyzer 16 applies a tag to an expression included in a predetermined sensitivity category in the processing target data S subjected to the morphological analysis processing (step S109).

As sensitivity categories, for example, “Cool,” “Charming,” “Sophistication,” “Highclass,” “Sporty,” “Individual,” “Simple,” “Masculine,” “Family,” “Traditional,” and the like are defined. In addition, as sensitivity words belonging to each of the sensitivity categories, in addition to the same words as names of these sensitivity categories, similar words to the names of these sensitivity categories are previously defined. The similar words may be defined, for example, by acquiring words associated with the same words as the names of the sensitivity categories from a database system such as Wikipedia on the Internet, and selecting words with high similarity on the basis of Cos similarity and the like.

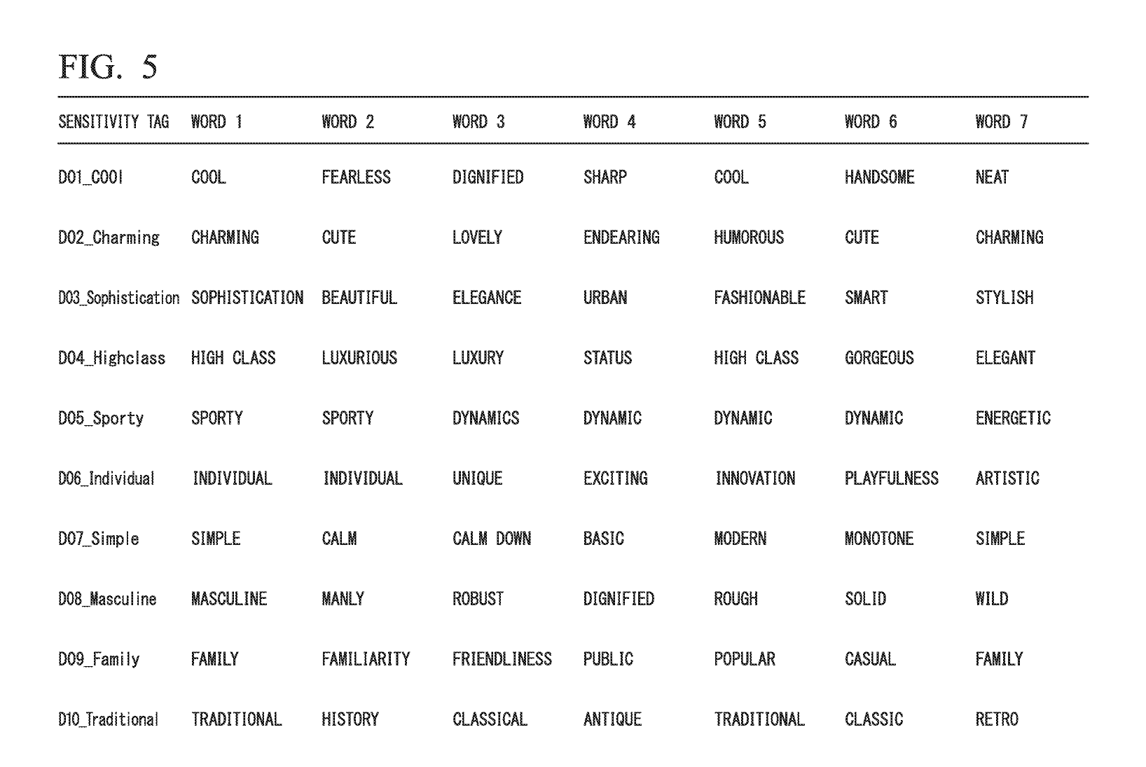

FIG. 5 is a diagram which shows an example of sensitivity tags set for each of the sensitivity categories and sensitivity words belonging to each of the sensitivity categories. As shown in FIG. 5, for example, the sensitivity words “Cool (Word1),” “Fearless (Word2), “Dignified (Word3),” “Sharp (Word4),” “Cool (Word 5),” “Handsome (Word 6),” and “Neat (Word 7)” are associated with a tag “D01_Cool (tag)” with respect to a sensitivity category of “Cool.”

Next, the analyzer 16 performs syntax analysis processing to interpret strength and weakness, multiple negation, positive question, dependency, and comparison of word expressions included in the text of the processing target data S (step S111). Interpretation of the strength and weakness of expressions is to interpret, for example, “extremely” in the expression “A product is extremely good,” as a stronger expression than “somewhat” in the expression “A product is somewhat good.” Interpretation of multiple negation is to correctly interpret, for example, an expression including double negation such as “A product is not bad,” as a positive expression.

Interpretation of positive question is to interpret, for example, the question sentence expressed with a positive intention “Isn't product A a good product?” as a positive expression. Interpretation of dependency is to correctly interpret the meaning of a sentence in which there is no subject by paying attention only to relationships between adjectives and verbs. Interpretation of dependency is to correctly interpret the meaning even when the position of a modifier is reversed like the expression of “A good product is product A, isn't it?” This “A good product is product A, isn't it?” is interpreted as a positive expression.

Interpretation of comparison is to determine that the expression “The previous model of product A was better,” in which a current model of the product A is compared with a previous model thereof means that the product A became worse, and to interpret it as a negative expression. It is possible to increase accuracy in understanding the meaning of the customer's comments, which are often written in a colloquial style, by performing the syntax analysis processing described above.

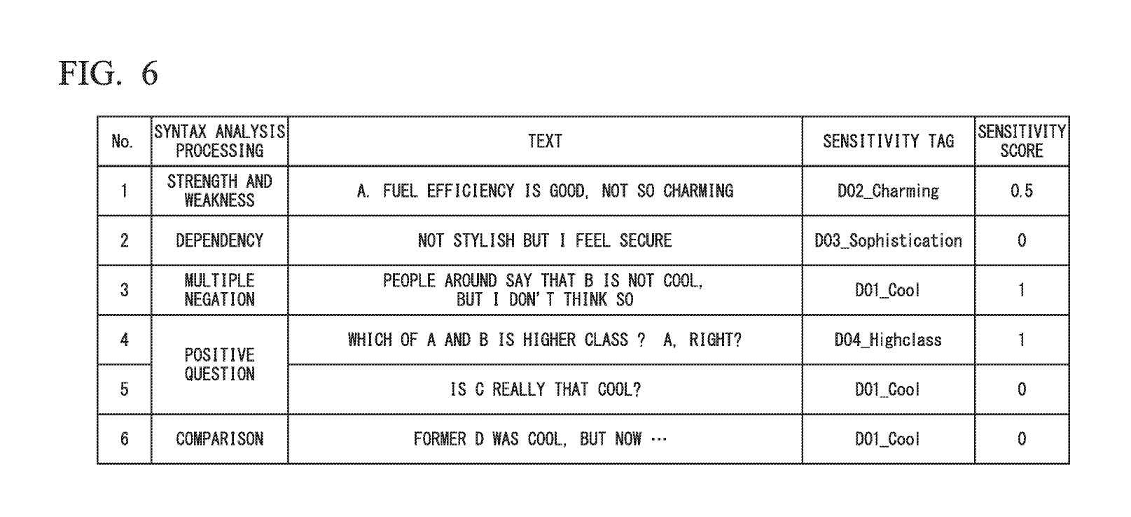

Next, the analyzer 16 performs scoring for calculating a score (hereinafter, referred to as “sensitivity score”) which is a numerical value indicating whether it is a positive tag (is it positive?) or a negative tag (is it negative?) for each sensitivity tag on text included in the processing target data S subjected to tagging (step S113) on the basis of the results of the syntax analysis processing described above. FIG. 6 is a diagram which shows an example of results of scoring according to the embodiment. In the example shown in FIG. 6, the analyzer 16 processes the text “A. fuel efficiency is good, not so charming” as data of “No. 1,” and applies “D02_Charming” which is a sensitivity tag of the sensitivity category “Charming” thereto on the basis of the word “charming.” Furthermore, the analyzer 16 performs syntax analysis processing of “strength and weakness,” determines that this text is text including a slightly negative expression on the basis of the words “not so,” and sets a sensitivity score of “0.5.”

The analyzer 16 processes the text “not stylish but I feel secure” as data of “No. 2,” and applies “D03_Sophistication” which is a sensitivity tag of the sensitivity category “Sophistication” thereto on the basis of the word “stylish.” Furthermore, the analyzer 16 performs the syntax analysis processing of “dependency,” appropriately analyzes the content of an expression in which even there is no subject, determines that the text includes a negative expression, and sets a sensitivity score of “0.”

The analyzer 16 processes the text “People around say that B is not cool, but I don't think so” as data of “No. 3,” and applies “D01_Cool” which is a sensitivity tag of the sensitivity category “Cool” thereto on the basis of the word “not cool.” Furthermore, the analyzer 16 performs the syntax analysis processing of “multiple negation,” determines that this text including multiple negation includes a positive expression, and sets a sensitivity score of “1.”

The analyzer 16 processes the text “Which of A and B is higher class? A, right?” as data of “No. 4,” and applies “D04 Highclass” which is a sensitivity tag of the sensitivity category “Highclass” thereto on the basis of the word “higher class.” Furthermore, the analyzer 16 performs the syntax analysis processing of “positive question,” determines that this text which is a positive question includes a positive expression, and sets a sensitivity score of “1.”

The analyzer 16 processes the text “Is C really that cool?” as data of “No. 5,” and applies “D01_Cool” which is a sensitivity tag of the sensitivity category “Cool” thereto on the basis of the word “cool.” Furthermore, the analyzer 16 performs the syntax analysis processing of “positive question,” determines that this text including a positive question includes a negative expression, and sets a sensitivity score of “O.”

In addition, the analyzer 16 processes the text “The former D was cool, but now . . . ” as data of “No. 6,” and applies “D01_Cool” which is a sensitivity tag of the sensitivity category “Cool” thereto on the basis of the word “cool.” Furthermore, the analyzer 16 performs the syntax analysis processing of “comparison,” determines that this text including a comparison includes a negative expression, and sets a sensitivity score of “O.”

After the processing for the image D1 (step S101 and step S103) and the processing for the processing target data S (steps S105 to S113) described above, the model generator 30 generates the evaluation model M by setting a set of the feature value of a design extracted by the feature extractor 12 and a sensitivity tag and a sensitivity score given by the analyzer 16 as teacher data and performing machine learning thereon for each vehicle (step S115). That is, the model generator 30 generates the evaluation model M which has learned a relationship between the feature value (vehicle) of a design and the sensitivity tag and sensitivity score for each vehicle. The model generator 30 stores the generated evaluation model M into the storage 20.

In the evaluation model M described above, for example, a sensitivity score for each sensitivity tag is defined for each vehicle type. For example, sensitivity scores for a vehicle “A” are defined such that the sensitivity score of the sensitivity tag “Cool” is “0.6,” the sensitivity score of “Charming” is “0.6,” the sensitivity score of the sensitivity tag “Sophistication” is “0.7,” the sensitivity score of the sensitivity tag “Highclass” is “0.3,” the sensitivity score of the sensitivity tag “Sporty” is “0.1,” the sensitivity score of the sensitivity tag “Individual” is “0.1,” the sensitivity score of the sensitivity tag “Simple” is “0.0,” the sensitivity score of the sensitivity tag “Masculine” is “0.1,” the sensitivity score of the sensitivity tag “Family” is “0.3,” and the sensitivity score of the sensitivity tag “Traditional” is “0.1.” In this case, it is ascertained that a customer tends to shows sensitivity of “sophistication” to the vehicle “A.” As described above, processing of this flowchart ends.

### (Evaluation Stage)

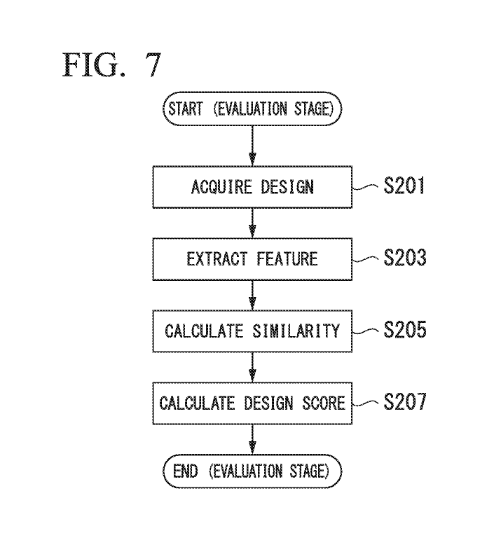

Hereinafter, the evaluation stage operation of the evaluation device 1 according to the present embodiment will be described. FIG. 7 is a flowchart which shows an example of the flow of processing in an evaluation stage of the evaluation device 1 according to the embodiment.

First, the first acquirer 10 acquires an image D10 of the design of a vehicle which is an evaluation target (step S201). The first acquirer 10 acquires an image D10 input by an operator via, for example, a receiver (not shown). The image D10 of the design of a vehicle which is an evaluation target is, for example, an image of the exterior design of a vehicle which is newly developed in the process of developing a new vehicle.

Next, the feature extractor 12 extracts the feature value of a design from the image D10 acquired by the first acquirer 10 (step S203). The feature extractor 12 uses, for example, the convolution neural network which is a type of deep learning.

Next, the similarity calculator 32 calculates similarity indicating how similar the design shown in the image D10 is to each of n vehicle types which are learning targets in the learning stage using the feature value extracted from the image D10 by the feature extractor 12 and the evaluation model M read from the storage 20 (step S205). For example, when the number of types of vehicles which are learning targets in the learning stage is ten (A to J), the similarity calculator 32 calculates similarity indicating how similar the design shown in the image D10 is to each of the 10 vehicle types (A to J). The similarity may be a value which increases as similarity to the design shown in the image D10 increases.

Next, the design score calculator 34 calculates a design score on the basis of similarity calculated by the similarity calculator 32, and a sensitivity tag and a sensitivity score given to each of n vehicle types defined as the evaluation model M (step S207).

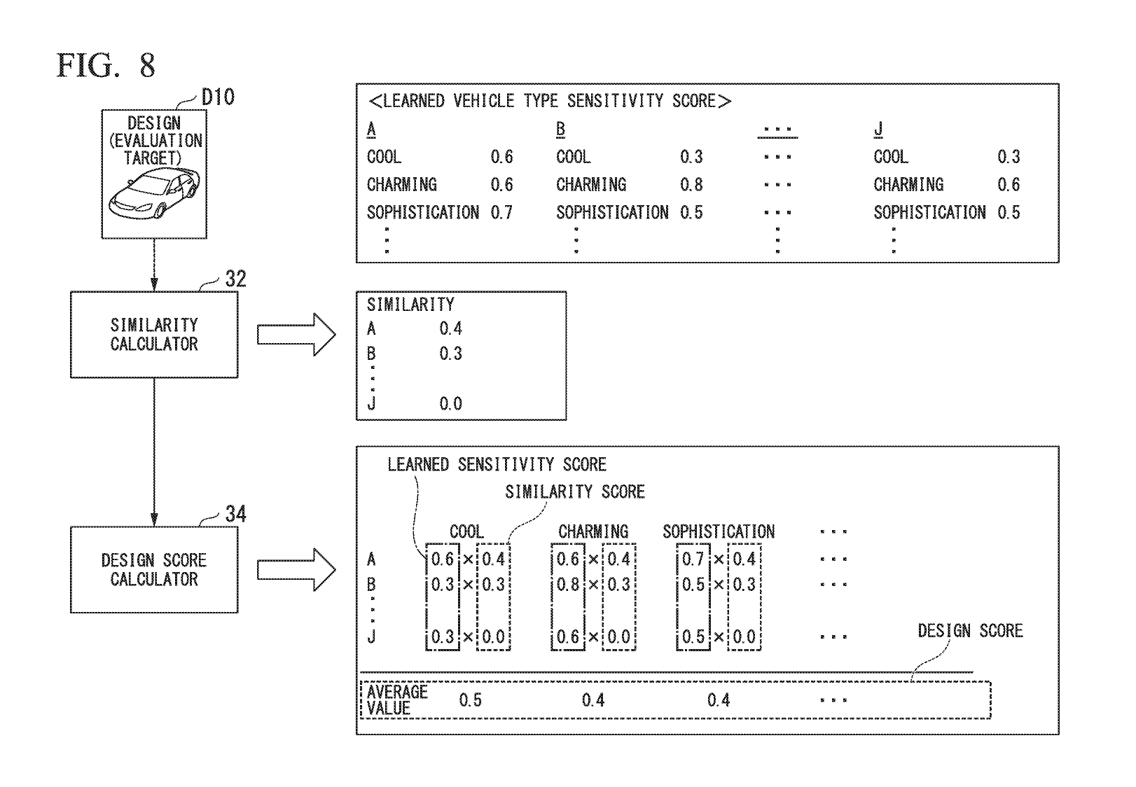

FIG. 8 is a diagram which shows calculation processing of similarity and a design score according to the present embodiment. In this example, the sensitivity scores of 10 vehicle types (A to J) shown in a “learned vehicle type sensitivity score” of FIG. 8 are previously learned in the learning stage. The similarity calculator 32 calculates similarity of each of 10 vehicle types (A to J) to the image D10 of the design of a vehicle which is an evaluation target. Next, the design score calculator 34 calculates a design score on the basis of the “learned vehicle type sensitivity score” and the similarity calculated by the similarity calculator 32. The design score calculator 34 may calculate, for example, an average value of values of all vehicle types obtained by multiplying a learned sensitivity score of each vehicle type and similarity of each vehicle type in each of the sensitivity tags as a design score.

The design score calculator 34 may calculate, for example, a design score as a configuration ratio by multiplying the learned sensitivity score and the similarity of each vehicle type in each of the sensitivity tags, adding the results for 10 vehicle types, and dividing the added value by a total sensitivity score of all sensitivity tags. The design score calculator 34 may calculate the design score of each sensitivity tag by using, for example, the following Equation (1).

$${Score}_{i , j} = \frac{{\sum }_{k = 1}^{10} ( {w}_{i , k} * {Score}_{k , j} )}{{\sum }_{j = 1}^{10} ( {Score}_{j} )} \qquad Equation ( 1 )$$

In Equation (1) described above, i represents a vehicle which is an evaluation target, j represents an identifier of the sensitivity category (sensitivity tag) (j=1, 2, . . . , 10), W_{i,k} represents similarity to a vehicle k (k=1, 2, . . . , 10) which is a learning target of the vehicle i which is an evaluation target, and Score represents a design score of the sensitivity category j in the vehicle i which is an evaluation target. As a result, for example, a composition ratio of the design score of each sensitivity tag for the vehicle “A” can be obtained such that a composition ratio of the sensitivity tag “Cool” is “30%,” a composition ratio of “Charming” is “20%,” . . . , and so forth.

According to the evaluation device of the present embodiment described above, confidentiality can be secured and the sensitivity of customers can be quantitatively evaluated in a simple manner. For example, when an image of an evaluation target is set to an image of the exterior design of a vehicle which is newly developed in the process of developing a new vehicle, it is possible to quantitatively evaluate the sensitivity of customers to this design while securing the confidentiality of the design of this newly developed vehicle. Moreover, in addition to this evaluation of sensitivity, it is also possible to ascertain how similar the design of this newly developed vehicle is to that of an existing vehicle.

Although the embodiment for carrying out the present invention has been described using an embodiment, the present invention is not limited to the embodiment, and various modifications and substitutions can be made within the scope not departing from the present invention.

What is claimed is:

1. An evaluation device comprising:
a feature extractor configured to extract a first feature value of a first design which is an evaluation target;
a similarity calculator configured to calculate similarity between the first design and each of a plurality of existing second designs on the basis of the first feature value extracted by the feature extractor; and
a predictor configured to predict a customer's impression of the first design on the basis of similarity calculated by the similarity calculator and information indicating a customer's impression of each of the second designs previously acquired.

2. The evaluation device according to claim 1, further comprising:
a model generator configured to generate, by learning a pair of a second feature value extracted from each of the plurality of second designs by the feature extractor and information indicating the customer's impression of each of the second designs obtained from an information medium, an evaluation model indicating a relationship between the second feature value and the information indicating the customer's impression.

3. The evaluation device according to claim 1, wherein
the predictor is configured to calculate a design score obtained by converting the customer's impression of the first design into a numerical value.

4. The evaluation device according to claim 1, further comprising:
an analyzer configured to calculate scores obtained by applying tags indicating predetermined types of information indicating a customer's impression to data obtained from an information medium and converting information indicating the customer's impression into a numerical value for each of the applied tags.

5. The evaluation device according to claim 1, wherein
the first design is a design of an unreleased vehicle and each of the second designs is a design of a released vehicle.

6. The evaluation device according to claim 1, wherein
the predictor is configured to predict a customer's impression of a new design image by performing machine learning of appearance images of existing vehicles and information indicating customer's impressions of the appearance images of existing vehicles.

7. An evaluation method comprising:
extracting a first feature value of a first design which is an evaluation target;
calculating similarity between the first design and each of a plurality of existing second designs on the basis of the extracted first feature value; and
predicting a customer's impression of the first design on the basis of the calculated similarity and information indicating a customer's impression of each of the second designs previously acquired.

8. A non-transitory computer-readable storage medium storing an evaluation program, which when executed by a computer, causes the computer to:
extract a first feature value of a first design which is an evaluation target;
calculate similarity between the first design and each of a plurality of existing second designs on the basis of the extracted first feature value; and
predict a customer's impression of the first design on the basis of the calculated similarity and information indicating a customer's impression of each of the second designs previously acquired.
